(19) United States
(12) Patent Application Publication
(10) Pub. No.: US 2009/0293338 A1
(43) Pub. Date: Dec. 3, 2009

(54) FISHING SINKER

(75) Inventor: Chia-Pu LU, Changhua (TW)

Correspondence Address: BROWDY AND NEIMARK, P.L.L.C.;624 NINTH STREET, NW, SUITE 300, WASHINGTON, DC, 20001-5303, US

(73) Assignee: Yuan Huang Enterprise Co., Ltd., Shiow Shui (TW)

(21) Appl. No.: 12/127,301

(22) Filed: May 27, 2008

(51) Int. Cl. A01K 75/06; A01K 95/00

(52) U.S. Cl. 43/9.8; 43/44.91; 43/43.1; 43/7

(57) ABSTRACT

A fishing sinker for use in fishing is disclosed to include a first weight member and a second weight member detachably fastened together, each weight member having a plastic shell and a metal block embedded in the plastic shell to prevent rust. Further, each weight member has a junction surface for bonding and a longitudinal groove that receives the fishing line of a fishing pole or one cord member of a fishing net when the two weight members are fastened together.

### BACKGROUND OF THE INVENTION

1. Field of the Invention

The present invention relates to fishing gears and more specifically, to a sinker used in fishing.

2. Description of the Related Art

Conventional fishing sinkers are commonly made out of lead. A fishing sinker may be used in a fishing pole to force a lure/bait to sink. Fishing sinkers may also be used in a fishing net to force one side of the fishing net to sink rapidly. Because lead may cause toxic lead poisoning in ingested and because this oxic lead poisoning has led to many waterbird deaths and unknown numbers of deaths in other aquatic organisms, the manufacturer now promotes iron-based fishing sinkers instead of the lead-based fishing sinker under the consideration of ecology protection.

Further, when sinkers are used in a fishing net, sinkers may be fastened to the cord members of the fishing net by means of a tying process after the formation of the fishing net. Alternatively, sinkers may be sleeved onto cord members before knotting of cord members to form a fishing net. These installation procedures are complicated, requiring much labor and time. Further, when wishing to repair the meshes, it is complicated to dismount the sinkers from the fishing net. Further, seawater causes an iron based sinker to rust quickly. Iron rust may cut off the treads of a fishing net easily. When a fishing net is covered with a big amount of iron rust, the fishing net may become useless.

Therefore, it is desirable to provide a fishing sinker that eliminates the aforesaid problems.

### SUMMARY OF THE INVENTION

The present invention has been accomplished under the circumstances in view. It is the main object of the present invention to provide a fishing sinker that does not cause metal to rust, and avoids metal pollution in the environment.

It is another object of the present invention to provide a fishing sinker, which is easy to mount and dismount in a rapid manner.

To achieve these and other objects of the present invention, the invention provides a fishing sinker that can easily and detachably fastened to the fishing line of a fishing pole or one cord member of a fishing net. The fishing sinker is comprised of a first weight member and a second weight member. The first weight member comprises a metal block, and a plastic shell covering the metal block. The plastic shell of the first weight member has a junction surface and a longitudinal receiving groove formed in the junction surface. The second weight member comprises a metal block, and a plastic shell covering the metal block. The plastic shell of the second weight member has a junction surface and a longitudinal receiving groove formed in the junction surface. By means of fastening the junction surface of the first weight member to the junction surface of the second weight member, the first and second weight members are secured together to surround the fishing line of the fishing pole or the cord member of the fishing net.

### BRIEF DESCRIPTION OF THE DRAWING

FIG. 1 is an exploded view of a fishing sinker in accordance with a first embodiment of the present invention.

FIG. 2 is a sectional view taken along line 2-2 of FIG. 1.

FIG. 3 is an applied view of the fishing sinker in accordance with the first embodiment of the present invention.

FIG. 4 is a side view of FIG. 3.

FIG. 5 is an exploded view of a fishing sinker in accordance with a second embodiment of the present invention.

FIG. 6 is an exploded view of a fishing sinker in accordance with a third embodiment of the present invention.

### DETAILED DESCRIPTION OF THE INVENTION

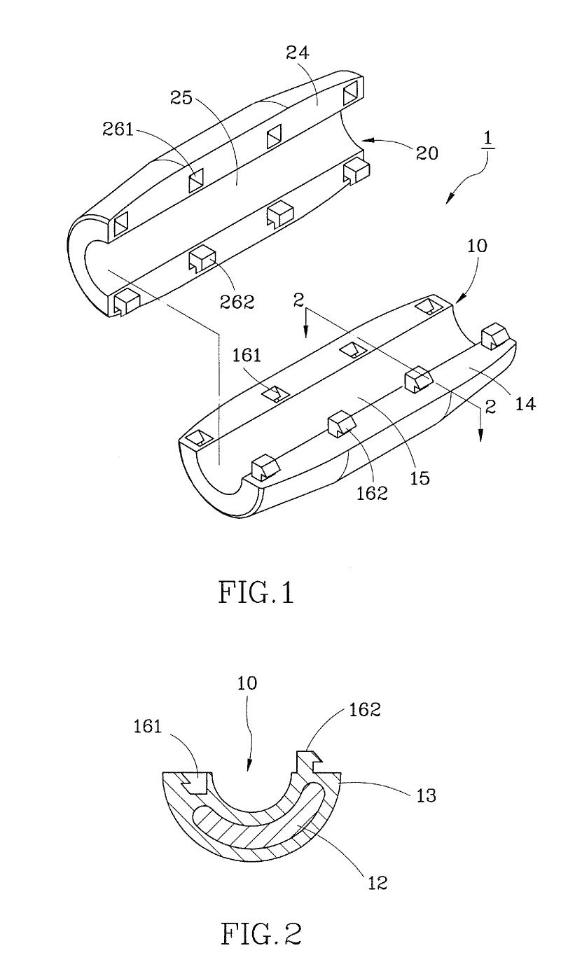

Referring to FIG. 1, a fishing sinker 1 in accordance with a first embodiment of the present invention is shown comprising a first weight member 10 and a second weight member 20.

The first weight member 10 comprises a metal block 12 and a plastic shell 13. The metal block 12 is prepared from, for example, lead or iron, and then put in a mold (not shown) to receive an injection molding process. The plastic shell 13 is molded on the metal block 12 from a plastic material through an injection molding technique. The first weight member 10 has a specific gravity greater than water. Further, the first weight member 10 has a substantially semicylindrical shape, and a junction surface 14. The junction surface 14 has a longitudinal receiving groove 15 on the middle, and a plurality of female retaining portions 161 and male retaining portions 162 symmetrically arranged at two opposite lateral sides of the longitudinal receiving groove 15. The female retaining portions 161 are retaining holes formed in the junction surface 14 and arranged in a line along one lateral side of the longitudinal receiving groove 15. The male retaining portions 162 are retaining blocks with hook portions protruded from the junction surface 14 and arranged in a line along the other lateral side of the longitudinal receiving groove 15.

The second weight member 20 is substantially similar to the first weight member 10 in shape and structure and prepared in the same manner as the first weight member 10, having a junction surface 24. The second weight member 20 has a specific gravity greater than water. Further, the junction surface 24 has a longitudinal receiving groove 25 on the middle, and a plurality of female retaining portions 261 and male retaining portions 262 symmetrically arranged at two opposite lateral sides of the longitudinal receiving groove 25. The female retaining portions 261 are retaining holes formed in the junction surface 24 and arranged in a line along one lateral side of the longitudinal receiving groove 25 corresponding to the male retaining portions 162 of the first weight member 10. The male retaining portions 262 are retaining blocks with hook portions protruded from the junction surface 24 and arranged in a line along the other lateral side of the longitudinal receiving groove 25 corresponding to the female retaining portion 161 of the first weight member 10.

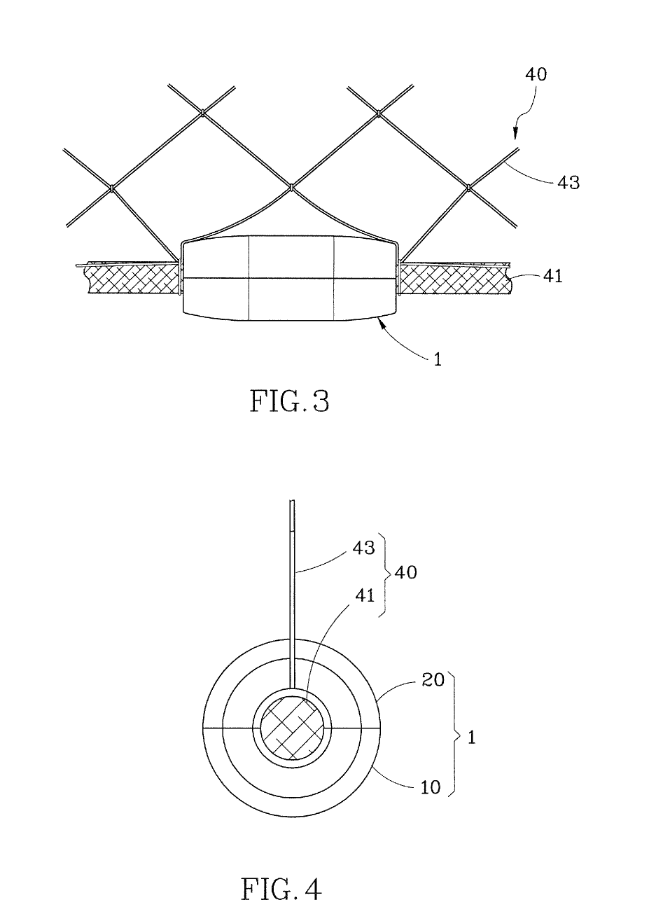

The fishing sinker can be fastened to the fishing line of a fishing pole (not shown) to force a lure or bait to sink. The fishing sinker can also be fastened to a fishing net 40. As shown in FIGS. 3 and 4, the fishing net is a piece of meshes formed of thick cords 41 and thin threads 43 by knotting. During installation, the first weight member 10 and the second weight member 20 are attached to one thick cord 41 from two sides to force the female retaining portions 161 and male retaining portions 162 of the first weight member 10 into engagement with the male retaining portions 262 and female retaining portions 261 of the second weight member 20, keeping the thick cord 41 in the longitudinal receiving grooves 15 and 25. After installation of a number of fishing sinkers 1 in the fishing net 40, the fishing sinkers 1 force the fishing net 40 to sink in water.

According to the present invention, the metal material of the fishing sinker 1 is embedded in the plastic material, therefore the plastic material prohibits rust on the metal material. Further, because the fishing sinker 1 is formed of the first weight member 10 and the second weight member 20 that are detachably fastened together, the fishing sinker 1 can easily and detachably fastened to a fishing net 40. When a repair work is necessary, the fishing sinker 1 can easily be detached from the fishing net 40. Therefore, the fishing sinker 1 can be used repeatedly.

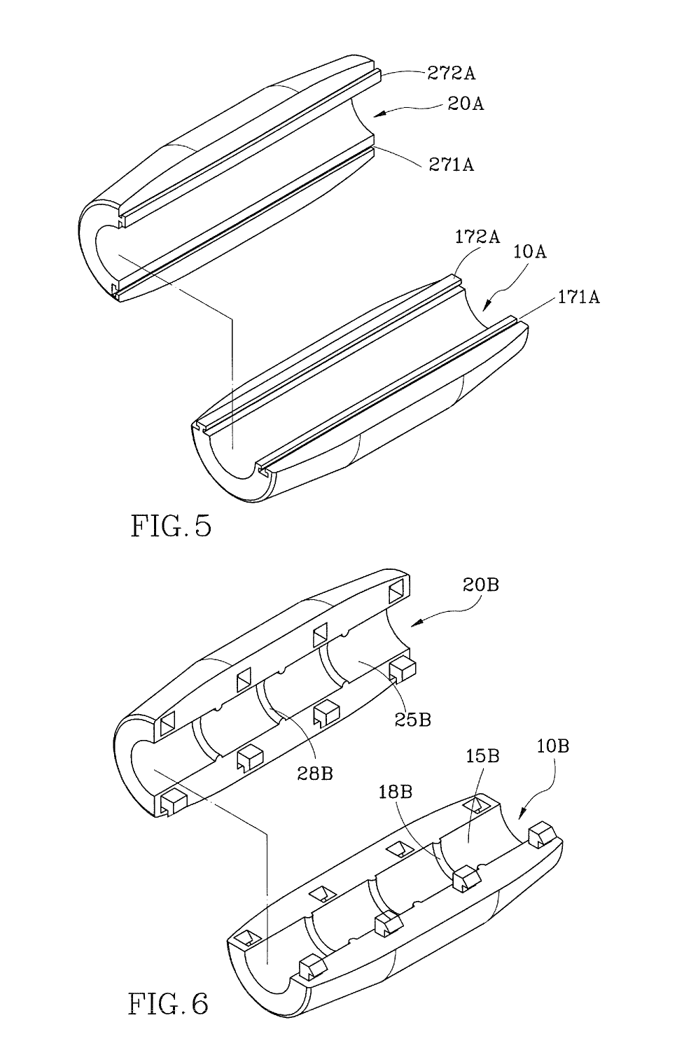

FIG. 5 is an exploded view of a fishing sinker in accordance with a second embodiment of the present invention. This second embodiment is substantially similar to the aforesaid first embodiment with the exception that longitudinal coupling grooves 171A and 271A and longitudinal coupling flanges 172A and 272A are respectively formed on the first and second weight members 10A and 20A for mounting. The longitudinal coupling grooves 171A and 271A and longitudinal coupling flanges 172A and 272A according to this embodiment have a T-shaped cross section. By means of inserting the longitudinal coupling flange 172A of the first weight member 10A into the longitudinal coupling groove 271A of the second weight member 20A and the longitudinal coupling flange 272A of the second weight member 20A into the longitudinal coupling groove 171A of the first weight member 10A, the first weight member 10A and the second weight member 20A are fastened together and secured to a fishing line or fishing net. Further, a high-frequency sealing technique or an adhesive may be used to affix the first weight member 10A and the second weight member 20A to a fishing net.

FIG. 6 is an exploded view of a fishing sinker in accordance with a third embodiment of the present invention. This third embodiment is substantially similar to the aforesaid first embodiment with the exception that the first weight member 10B and the second weight member 20B each have a plurality of elastic locating portions 18B or 28B transversely disposed in the respective longitudinal receiving groove 15B or 25B. The elastic locating portions 28B according to this embodiment are semicircular elastic ribs. Therefore, one semicircular elastic rib of the first weight member 10B and one corresponding semicircular elastic rib of the second weight member 20B form an annular elastic rib. When the first weight member 10B and the second weight member 20B are attached to a thick cord of a fishing net (not shown) and fastened together, the elastic locating portions 18B of the first weight member 10B and the elastic locating portions 28B of the second weight member 20B are respectively abutted against the periphery of the thick cord, enhancing the connection between the fishing sinker and the thick cord. Further, elastic locating portions 18B and 28B can be elastic strips or pegs.

Further, the metal blocks embedded in the first and second weight members 10 and 20 can be lead, iron, cast iron, zinc, or any other cheap heavy material, such that the first and second weight members 10 and 20 have a specific weight greater than water. When the fishing sinker is fastened to a fishing line or fishing net, it forces the fishing line or fishing net to sink. Further, because a plastic material is used to surround the metal blocks of the fishing sinker, the invention prevents heavy metal pollution.

As stated above, the invention provides a fishing sinker that is formed of two symmetrical halves each having a metal block embedded in plastic shell. Therefore, the fishing sinker prevents rust and heavy metal pollution. Further, the two symmetrical halves are detachably fastened together by means of joint means, and therefore the user can easily and rapidly fasten the fishing sinker to a fishing line or fishing net.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A fishing sinker for being fastened on a line of a fishing device, comprising:
a first weight member, said first weight member comprising a metal block and a plastic shell covering the metal block of said first weight member, the plastic shell of said first weight member having a junction surface and a longitudinal receiving groove formed in the junction surface of said first weight member and extending through two distal ends of the junction surface of said first weight member for receiving said line of said fishing device; and
a second weight member, said second weight member comprising a metal block and a plastic shell covering the metal block of said second weight member, the plastic shell of said second weight member having a junction surface for abutting against the junction surface of said first weight member and a longitudinal receiving groove formed in the junction surface of said second weight member and extending through two distal ends of the junction surface of said second weight member for receiving said line of said fishing device.

2. The fishing sinker as claimed in claim 1, wherein the metal blocks of said first weight member and said second weight member are prepared from iron.

3. The fishing sinker as claimed in claim 1, wherein said first weight member comprises a plurality of male retaining portions and female retaining portions symmetrically disposed at the junction surface of said first weight member at two opposite lateral sides of the longitudinal receiving groove of said first weight member; said second weight member comprises a plurality of female retaining portions and male retaining portions symmetrically disposed at the junction surface of said second weight member at two opposite lateral sides of the longitudinal receiving groove of said second weight member and respectively forced into engagement with the male retaining portions and female retaining portions of said first weight member.

4. The fishing sinker as claimed in claim 1, wherein said first weight member comprises a longitudinal coupling groove and a longitudinal coupling flange respectively disposed at the junction surface of said first weight member at two opposite lateral sides of the longitudinal receiving groove of said first weight member; said second weight member comprises a longitudinal coupling flange and a longitudinal coupling groove respectively disposed at the junction surface of said second weight member at two opposite lateral sides of the longitudinal receiving groove of said second weight member and respectively coupled to the longitudinal coupling groove and longitudinal coupling flange of said first weight member.

5. The fishing sinker as claimed in claim 1, wherein the junction surface of said first weight member and the junction surface of said second weight member are bonded together and affixed to said line of said fishing device by high-frequency sealing.

6. The fishing sinker as claimed in claim 1, wherein the junction surface of said first weight member and the junction surface of said second weight member are bonded together and affixed to said line of said fishing device with an adhesive.

7. The fishing sinker as claimed in claim 1, wherein the junction surface of said first weight member and said second weight member each have a plurality of locating portions respectively disposed in the longitudinal receiving grooves of said first weight member and said second weight member.

8. The fishing sinker as claimed in claim 7, wherein the locating portions of said first weight member and said second weight member are elastic ribs respectively disposed in the longitudinal receiving grooves of said first weight member and said second weight member.

9. The fishing sinker as claimed in claim 7, wherein the locating portions of said first weight member and said second weight member are elastic strips respectively disposed in the longitudinal receiving grooves of said first weight member and said second weight member.

10. The fishing sinker as claimed in claim 7, wherein the locating portions of said first weight member and said second weight member are elastic pegs respectively disposed in the longitudinal receiving grooves of said first weight member and said second weight member.
